(19) United States
(12) Patent Application Publication
(10) Pub. No.: US 2020/0347983 A1
(43) Pub. Date: Nov. 5, 2020

(54) DISPLAY BRACKET

(71) Applicants: HKC CORPORATION LIMITED, Shenzhen (CN); CHONGQING HKC OPTOELECTRONICS TECHNOLOGY CO., LTD., Chongqing (CN)

(72) Inventor: Qiong WU, Chongqing (CN)

(21) Appl. No.: 16/754,541

(22) PCT Filed: Dec. 20, 2017
(86) PCT No.: PCT/CN2017/117330

§ 371 Date: Apr. 8, 2020

(30) Foreign Application Priority Data
Oct. 12, 2017 (CN) 201710948369.9

(51) Int. Cl. F16M 11/04; F16M 13/02

(52) U.S. Cl. CPC F16M 11/04; F16M 11/24; F16M 13/02

(57) ABSTRACT

Disclosed is a display bracket including a support arm, a base, and a switch. The support arm includes a first arm rod and a second arm rod connected to one another, a free end of the first arm rod is connected to a display, a free end of the second arm rod is connected to the base. The base is magnetizable, and the switch provided on the base is used for adjusting a magnitude of magnetism of the base. The display is movable with respect to the base under an action of the support arm.

### TECHNICAL FIELD

The present disclosure relates to the field of display technology, and more particularly relates to a display bracket.

### BACKGROUND

Currently, there are various ways for a display bracket base to be fixed on a placement surface. For example, when the bracket has a base with a large size, the base may be directly placed on a table; or, when the bracket has a base with a small size, the base may pass through a hole of the table, and then be tightened on the table by a lock; or, by a clamp installation, the base of the bracket is clamped on an edge of the table, and so on. The fixed methods above have their own disadvantages. For the first one, to ensure the center of gravity of the bracket, the base is designed to have a large size, which takes more space of the table. For the second one, the table should be punched to define a hole, thus the table is damaged to a certain degree. For the third one, the base needs to be clamped to the edge of the table, thus the position for placing the display is limited. Additionally, in all the ways, the display bases are generally fixed on a certain horizontal plane, the ways to place the display here are inflexible.

### SUMMARY

The present disclosure provides a display bracket, which provides much more selections for the placement of displays.

In one aspect, the present disclosure provides a display bracket including:

a support arm comprising a first arm rod and a second arm rod connected to one another, a free end of the first arm rod being connected to a display;

a base connected to a free end of the second arm rod, the base being magnetizable; and

a switch arranged on the base, the switch being configured for adjusting a magnitude of magnetism of the base;

the display being movable with respect to the base under an action of the support arm.

In another aspect, the present disclosure provides another display bracket including:

a support arm comprising a first arm rod and a second arm rod connected to one another, a free end of the first arm rod being connected to a display;

a base connected to a free end of the second arm rod, the base being magnetizable; the base comprising a base core, a base body, and an interlayer, the base core being made of a permanent magnetic material, the base body being wrapped around the base core and made of a soft magnetic material, the interlayer being clamped in the base body and dividing the base body into two separate parts, the interlayer being connected to the base core, the base core being symmetric with respect to the interlayer, the interlayer being made of a non-magnetic material, an N pole and an S pole of the base core being freely rotatable in a plane perpendicular to the interlayer;

a switch arranged on the base, the switch being configured for adjusting a magnitude of magnetism of the base;

the display being movable with respect to the base under an action of the support arm; and

a connector, one end of the connector being movably connected to the first arm rod, the other end of the connector being fixedly connected to the display, the display being allowed to make a lockable free movement with respect to the first arm rod through the connector;

wherein the first arm rod and the second arm rod are connected by means of a freely lockable hinged connection, the connector comprises a first member and a second member connected to one another, the first member is connected to the first arm rod, the second member is fixedly connected to the display, the first member and the first arm rod are connected by means of a hinged connection, the second member is rotatable around a fixed axis with respect to the first member, the second arm rod is rotatable around a fixed axis with respect to the base.

In still another aspect, the present disclosure provides another display bracket including:

a support arm comprising a first arm rod and a second arm rod connected to one another, a free end of the first arm rod being connected to a display;

a base connected to a free end of the second arm rod, the base being magnetizable; and

a switch arranged on the base, being configured for adjusting a magnitude of magnetism of the base;

the display being movable with respect to the base under an action of the support arm, the first arm rod and the second arm rod being connected by means of a freely lockable hinged connection, and the second arm rod being rotatable around a fixed axis with respect to the base.

In accordance with the present disclosure, a support arm including a first arm rod and a second arm rod connected to a first arm rod is provided, a free end of the first arm rod is connected to a display, a free end of the second arm rod is connected to a magnetizable base, and a switch is arranged on the base for adjusting the magnitude of the magnetism of the base. The display is movable with respect to the base under the action of the support arm, which provides much more selections for the placement of the display, thereby making the placement of display more flexible, and satisfying users' need of viewing from more angles.

### BRIEF DESCRIPTION OF THE DRAWINGS

In order to more clearly illustrate the embodiments of the present disclosure or the technical solutions in the prior art, the drawings used in the embodiments or the prior art description will be briefly introduced below. Obviously, the drawings in the following description are merely some of the embodiments of the present disclosure, and those skilled in the art can obtain other drawings according to the structures shown in the drawings without any creative work.

FIG. 1 is a structure diagram of a display bracket of an embodiment according to the present disclosure.

FIG. 2 is a structure diagram of a base of the display bracket of an embodiment according to the present disclosure.

FIG. 3 is a structure diagram of the base of the display bracket in a non-magnetic status of an embodiment according to the present disclosure.

FIG. 4 is a structure diagram of the base of the display bracket in a magnetic status of an embodiment according to the present disclosure.

FIG. 5 is a structure diagram of a connector of the display bracket of an embodiment according to the present disclosure.

### DETAILED DESCRIPTION OF THE EMBODIMENTS

The technical solutions in the embodiments of the present disclosure are clearly and completely described in the following with reference to the accompanying drawings in the embodiments of the present disclosure. It will be appreciated that the described embodiments are merely part of the embodiments of the present disclosure, rather than all the embodiments. Based on the embodiments in the present disclosure, all other embodiments obtained by those skilled in the art without creative efforts are within the scope of the present disclosure.

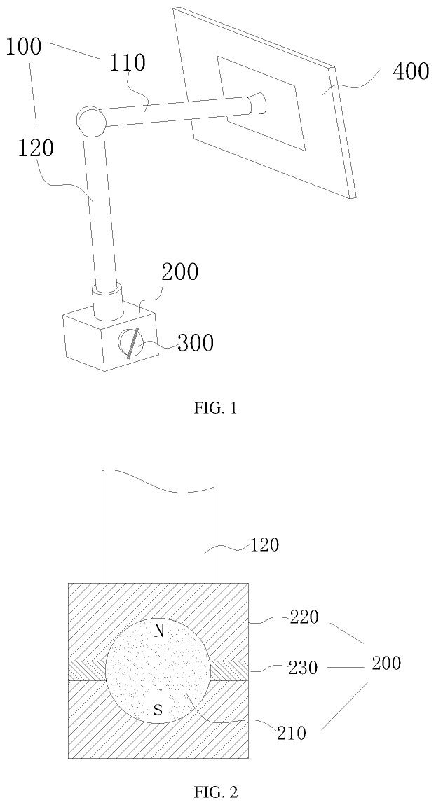

Referring to FIG. 1, a display bracket provided by an embodiment according to the present disclosure includes a support arm 100, a base 200 and a switch 300. The support arm 100 includes a first arm rod 110 and a second arm rod 120 connected to one another, the free end of the first arm rod 110 is connected to the display 400, the free end of the second arm rod 120 is connected to the base 200. The base 200 is a magnetic base. The switch 300 is provided on the base 200, and used for adjusting the magnitude of the magnetism of the base 200. The display 400 is movable with respect to the base 200 under the action of the support arm 100.

Specifically, the display bracket provided by the embodiment according to the present disclosure includes a support arm 100 and a base 200. The support arm 100 includes a first arm rod 110 and a second arm rod 120 connected to one another. The free end of the first arm rod 110, namely the end that is not connected to the second arm rod 120, is connected to the display 400. The free end of the second arm rod 120 is connected to the base 200. The base 200 is a magnetizable base, that is, the magnitude of the magnetism of the base 200 can be adjusted freely. The switch 300 provided on the base 200 is used for adjusting the magnitude of the magnetism of the base 200. When the base 200 is magnetic, the base 200 can be attracted to any position that can be attracted, such as an iron gate, an iron plate, a magnetically conductive steel plate and so on. The display can be fixed by switching on the magnetism of the base 200. When switching off the magnetism of the base 200, the base 200 is no longer attracted to the fixed position, the bracket can be freely removed. And when the base 200 is fixed by magnetic attraction, the display 400 is movable relative to the base 200 under the action of the support arm 100, that is, the support arm 100 is freely movable. The display 400 is freely movable over a wide range by swinging the support arm 100. In some embodiments, the magnetism of the base 200 is realized by a permanent magnet assembled by a special structure, or realized by an electromagnet, as long as the magnetism of the base to the external is freely switched on and off.

Specifically, the support arm 100 including a first arm rod 110 and a second arm rod 120 connected to one another is provided. The free end of the first arm rod 110 is connected to the display 400, the free end of the second arm rod 120 is connected to the magnetizable base, and the switch 300 is arranged on the base 200 for adjusting the magnitude of the magnetism of the base 200, the display 400 is movable relative to the base 200 under the action of the support arm 100, which provides more selections for the placement positions of the display 400, thereby making the placement more flexible and satisfying users' need of viewing from more angles.

Referring to FIG. 2, the base 200 includes a base core 210, a base body 220 and an interlayer 230. The base core 210 is made of permanent magnetic material. The base body 220 is wrapped around the base core 210, and made of soft magnetic material. The interlayer 230 is clamped in the base body 220, and divides the base body 220 into two separate parts; the interlayer 230 is connected to the base core 210, the base core 210 is symmetric with respect to the interlayer 230; the interlayer 230 is made of non-magnetic material, the N pole and S pole of the base core 210 is freely rotatable in a plane perpendicular to the interlayer 230.

Specifically, in this embodiment, the base core 210 with a permanent magnet assembled in a special structure is used to realize the switching on and off of magnetism of the base 200. The base 200 includes a base core 210, a base body 220 and an interlayer 230. The base core 210 of permanent magnetism is disposed inside the base body 220 which is made of soft magnetic material, and the base body 220 is divided into two parts by the interlayer 230 which is made of non-magnetic material. The base core 210 is connected to the interlayer 230, and is freely rotatable in a plane perpendicular to the interlayer 230. When the N pole and S pole of the base core 210 are rotated into a plane parallel to the interlayer 230, the magnetic force line of the base core 210 forms a closed circuit in the base 200 separated by the interlayer 230, and at this time, the surface of the base 200 is non-magnetic, failing to be absorbed to a magnetically conductive part outside. When the N pole and S pole of the base core 210 are rotated into a plane perpendicular to the interlayer 230, closing to the magnetically conductive part, the magnetic force line of the base core 210 starts from the N pole, passes through the base body 220 to the magnetically conductive part, returns to the base body 220 from the magnetically conductive part, and then returns to the S pole from the base 200, thereby forming a loop circuit, and at this time, the surface of the base 200 is magnetic, absorbed to the magnetically conductive part. In some embodiments, the rotation of the base core 210 is realized by the switch 300.

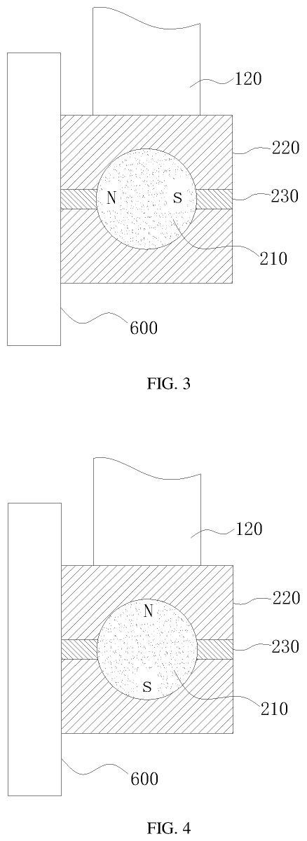

Referring to FIG. 3 and FIG. 4, the base 220 has a cuboid structure, the base core 210 is a round pie-shaped magnet arranged in the base body 220. The interlayer 230 is a non-magnetic plate which is clamped in the base body 220 to divide the base body 220 into two independent parts. The interlayer 230 is perpendicular to the round surface of the base core 210, and provided with an opening suitable in size for the base core 210 to pass through. The base core 210 is symmetrically distributed on two sides of the interlayer 230, the base core 210 is rotatable around a fixed axis in a plane perpendicular to the interlayer 230 under the action of the switch 300.

Specifically, as illustrated in FIG. 3, when the N pole and S pole of the base core 210 are rotated into a plane parallel to the interlayer 230, the magnetic force line of the base core 210 forms a closed circuit in the base 200 separated by the interlayer 230, and at this time, the surface of the base 200 is non-magnetic, failing to absorb the magnetically conductive part 600 outside; when the N pole and S pole of the base core 210 are rotated into a plane perpendicular to the interlayer 230, as illustrated in FIG. 4, closing to the magnetically conductive part 600, the magnetic force line of the base core 210 starts from the N pole, passes through the base body 220 to the magnetically conductive part 600, returns to the base body 220 from the magnetically conductive part 600, and then returns to the S pole from the base 200, thereby forming a loop circuit, and at this time, the surface of the base 200 is magnetic, absorbed to the magnetically conductive part 600, which realizes the on and off of the magnetism of the base 200. The switch 300 may be connected to an axis of the base core 210 for fixed-axis rotation, so as to drive the base core 210 to rotate about the fixed axis.

In some embodiments, the first arm rod 110 is connected to the second arm rod 120 through a freely lockable hinged connection.

Specifically, in order to realize the free movement of the display 400 driven by the support arm 100, in some embodiments, the first arm rod 110 and the second arm rod 120 are connected by means of a hinged connection. After the second arm rod 120 is fixed by the base 200, the first arm rod 110 is used for realizing the movement of the display 400 through the hinged connection part, and the hinged connection part is freely lockable, so as to facilitate locking the display 400 after the display 400 is adjusted to a predetermined position, preventing it from shaking. In some embodiments, for example, the first arm rod 110 is configured to perform a 320-degree rotation adjustment with respect to the second arm rod 120. The specific rotation angle can be designed according to needs.

In some embodiments, the second arm rod 120 is rotatable around a fixed axis with respect to the base 200.

Specifically, in some embodiments, the second arm rod 120 is fixed on the base 200 through a fixed axis, and is rotatable around the fixed axis, so that the display 400 is allowed to swing with the second arm rod 120, providing more placement freedom for the display 400. In one embodiment, for example, the first arm rod 110 is configured to perform a 320-degree rotation adjustment with respect to the base 200. The specific rotation angle can be designed according to needs.

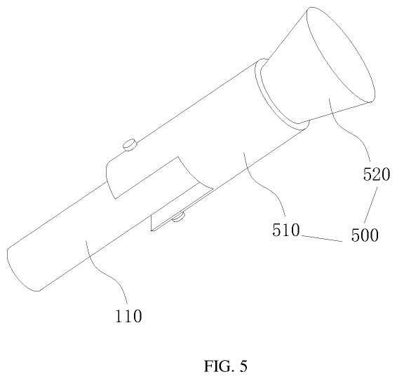

Referring to FIG. 5, the display bracket also includes a connector 500. The first arm rod 110 is connected to the display 400 through the connector 500, one end of the connector 500 is fixedly connected to the display 400, the other end of the connector 500 is movably connected to the first arm rod 110. The display 400 is allowed to make a lockable free movement with respect to the first arm rod 110 via the connector 500.

Specifically, the connector 500 is defined between the first arm rod 110 and the display 400, so that the display 400 has more freedom via the connector 500, which provides more selections of viewing angles for users, and brings users a better viewing experience.

In some embodiments, the connector 500 includes a first member 510 and a second member 520 connected to one another. The first member 510 is connected to the first arm rod 110, and the second member 520 is fixedly connected to the display 400.

Specifically, the display 400 has more freedom relative to the first arm rod 110 via the first member 510 and the second member 520 of the connector 500, such as rotation and swing, which greatly improves the display freedom of the display 400, facilitating users to set viewing angles flexibly and freely according to needs.

In some embodiments, the first member 510 and the first arm rod 110 are connected by means of a hinged connection, the second member 520 is rotatable around a fixed axis relative to the first member 510.

In some embodiments, the first member 510 and the second member 520 are connected by means of a hinged connection, the first member 510 is rotatable around a fixed axis relative to the first arm rod 110.

Specifically, as illustrated in FIG. 5, the first member 510 and the first arm rod 110 are connected by means of a hinged connection, the second member 520 is rotatable around a fixed axis relative to the first member 510. The case that the first member 510 and the second member 520 are connected by means of a hinged connection, and the first member 510 is rotatable around a fixed axis relative to the first arm rod 110 is not specifically shown, which achieves the same purpose of improving the placement freedom of the display 400.

Specifically, in above embodiments, the angles of relative swing or rotation between connection parts can be set according to actual needs, and the connection manners between the above connection parts, such as fixed-axis rotation, hinged connection, and so on, can also be replaced according to actual needs. For example, the first arm rod 110 may be connected to the second arm rod 120 through a fixed-axis rotation, the second arm rod 120 may be connected to the base 200 through a hinged connection, every connection part is freely lockable.

Referring to FIGS. 1 to 5, the present disclosure also provides another display bracket. The display bracket includes a support arm 100, a base 200, a switch 300 and a connector 500. The support arm 100 includes a first arm rod 110 and a second arm rod 120 connected to one another, the free end of the first arm rod is connected to the display 400, the free end of the second arm rod 120 is connected to the base 200. The base 200 is a magnetic base. The base 200 includes a base core 210, a base body 220 and an interlayer 230.The base core 210 is made of permanent magnetic material. The base body 220 is wrapped around the base core 210, and the base body 220 made of soft magnetic material. The interlayer 230 is clamped in the base body 220, and divides the base body 220 into two separate parts, the interlayer 230 is connected to the base core 210, and the base core 210 is symmetrically distributed on both sides of the interlayer 230, the interlayer 230 is made of non-magnetic material, the base core 210 is freely rotatable in a plane perpendicular to the interlayer 230. The switch 300 is used for adjusting the magnitude of the magnetism of the base 200. The display 400 is movable relative to the base 200 under the action of the support arm 100. The first arm rod 110 is connected to the display 400 via the connector 500, one end of the connector 500 is fixedly connected to the display 400, the other end of the connector 500 is movably connected to the first arm rod 110. The display 400 makes a lockable free movement relative to the first arm rod 110 via the connector 500. The first arm rod 110 is connected to the second arm rod 120 through a freely lockable hinged connection. The connector 500 includes a first member 510 and a second member 520. The first member 510 is connected to the first arm rod 110, the second member 520 is fixedly connected to the display 400. The first member 510 and the first arm rod 110 are connected by means of a hinged connection, the second member 520 is rotatable around a fixed axis relative to the first member 510. Further, the second arm rod 120 may be rotatable around a fixed axis relative to the base 200. In one embodiment, for example, the display 400 is configured to perform a 360-degree rotation adjustment and a 90-degree swing adjustment in the swing direction under the action of the connector 500. The angle range of adjustment can be set according to specific needs. The display bracket may be fixed to any magnetizable position by the magnetism of the base 200, increasing placement selections of the display; and the structure of the support arm 100 and the connector 500 provides more selections for viewing freedom of the display 400, such as adjusting the viewing angle and switching horizontal and vertical screens at any time, bringing users a better viewing experience.

In the embodiments above, the display 400 may be displays of various kinds, such as a Liquid Crystal display, an Organic Light Emitting Diode (OLED) display, a Quantum Dot Light Emitting Diodes (QLED) display, a curved display or other displays.

The foregoing description merely portrays some illustrative embodiments in accordance with the disclosure and therefore is not intended to limit the patentable scope of the disclosure. Any equivalent structure or flow transformations that are made taking advantage of the specification and accompanying drawings of the disclosure and any direct or indirect applications thereof in other related technical fields shall all fall in the scope of protection of the disclosure.

### SUMMARY OF THE DISCLOSURE

[symbol]

### TECHNICAL PROBLEM

[symbol]

### SOLUTION FOR THE TECHNICAL PROBLEM

[symbol]

### EFFECTS OF THE DISCLOSURE

[symbol]

What is claimed is:

1. A display bracket, comprising:
a support arm comprising a first arm rod and a second arm rod connected to one another, a free end of the first arm rod being connected to a display;
a base connected to a free end of the second arm rod, the base being magnetizable; and
a switch arranged on the base, the switch being configured for adjusting a magnitude of magnetism of the base;
wherein the display is movable with respect to the base under an action of the support arm.

2. The display bracket according to claim 1, wherein the base comprises:
a base core, made of a permanent magnetic material;
a base body, the base body being wrapped around the base core and made of a soft magnetic material; and
an interlayer, the interlayer being clamped in the base body and dividing the base body into two separate parts, the interlayer being connected to the base core, the base core being symmetric with respect to the interlayer, the interlayer being made of a non-magnetic material, an N pole and an S pole of the base core being freely rotatable in a plane perpendicular to the interlayer under a control of the switch.

3. The display bracket according to claim 2, wherein the base has a cuboid structure, the base core is a round pie-shaped magnet arranged in the base body, the interlayer is a non-magnetic plate that is clamped in the base body and divides the base body into the two separate parts, the interlayer is perpendicular to a round surface of the base core and is provided with an opening suitable in size for the base core to pass through, the base core is symmetrically distributed on two sides of the interlayer, and the base core is rotatable around a fixed axis in the plane perpendicular to the interlayer under the control of the switch.

4. The display bracket according to claim 1, wherein the first arm rod and the second arm rod are connected by means of a freely lockable hinged connection.

5. The display bracket according to claim 1, wherein the second arm rod is rotatable around a fixed axis with respect to the base.

6. The display bracket according to claim 1, further comprising:
a connector, one end of the connector being movably connected to the first arm rod, the other end of the connector being fixedly connected to the display, the display being allowed to make a lockable free movement with respect to the first arm rod via the connector.

7. The display bracket according to claim 6, wherein the connector comprises a first member and a second member connected to one another, the first member is connected to the first arm rod, and the second member is fixedly connected to the display.

8. The display bracket according to claim 7, wherein the first member and the first arm rod are connected by means of a hinged connection, and the second member is rotatable around a fixed axis with respect to the first member.

9. The display bracket according to claim 7, wherein the first member and the second member are connected by means of a hinged connection, and the first member is rotatable around a fixed axis with respect to the first arm rod.

10. A display bracket, comprising:
a support arm comprising a first arm rod and a second arm rod connected to one another, a free end of the first arm rod being connected to a display;
a base connected to a free end of the second arm rod, the base being magnetizable; the base comprising a base core, a base body, and an interlayer, the base core being made of a permanent magnetic material, the base body being wrapped around the base core and made of a soft magnetic material, the interlayer being clamped in the base body and dividing the base body into two separate parts, the interlayer being connected to the base core, the base core being symmetric with respect to the interlayer, the interlayer being made of a non-magnetic material, an N pole and an S pole of the base core being freely rotatable in a plane perpendicular to the interlayer;
a switch arranged on the base, the switch being configured for adjusting a magnitude of magnetism of the base;
the display being movable with respect to the base under an action of the support arm; and
a connector, one end of the connector being movably connected to the first arm rod, the other end of the connector being fixedly connected to the display, the display being allowed to make a lockable free movement with respect to the first arm rod through the connector;
wherein the first arm rod and the second arm rod are connected by means of a freely lockable hinged connection, the connector comprises a first member and a second member connected to one another, the first member is connected to the first arm rod, the second member is fixedly connected to the display, the first member and the first arm rod are connected by means of a hinged connection, the second member is rotatable around a fixed axis with respect to the first member, the second arm rod is rotatable around a fixed axis with respect to the base.

11. The display bracket according to claim 10, wherein the base has a cuboid structure, and the base core is a round pie-shaped magnet arranged in the base body.

12. The display bracket according to claim 10, wherein the interlayer is a non-magnetic plate that is clamped in the base body and divides the base body into the two separate parts, the interlayer is perpendicular to a surface of the base core, and defined with an opening suitable in size for the base core to pass through.

13. The display bracket according to claim 10, wherein the base core is symmetrically distributed on two sides of the interlayer, and the base core is rotatable around a fixed axis in a plane perpendicular to the interlayer under an action of the switch.

14. A display bracket, comprising:
a support arm comprising a first arm rod and a second arm rod connected to one another, a free end of the first arm rod being connected to a display;
a base connected to a free end of the second arm rod, the base being magnetizable; and
a switch arranged on the base, being configured for adjusting a magnitude of magnetism of the base,
wherein the display is movable with respect to the base under an action of the support arm, the first arm rod and the second arm rod are connected by means of a freely lockable hinged connection, and the second arm rod is rotatable around a fixed axis with respect to the base.

15. The display bracket according to claim 14, wherein the base comprises:
a base core, made of a permanent magnetic material;
a base body, the base body being wrapped around the base core and made of a soft magnetic material; and
an interlayer, the interlayer being clamped in the base body and dividing the base body into two separate parts, the interlayer being connected to the base core, the base core being symmetric with respect to the interlayer, the interlayer being made of a non-magnetic material, an N pole and an S pole of the base core being freely rotatable in a plane perpendicular to the interlayer under a control of the switch.

16. The display bracket according to claim 15, wherein the base has a cuboid structure, the base core is a round pie-shaped magnet arranged in the base body, the interlayer is a non-magnetic plate that is clamped in the base body and divides the base body into the two separate parts, the interlayer is perpendicular to a round surface of the base core and is provided with an opening suitable in size for the base core to pass through, the base core is symmetrically distributed on two sides of the interlayer, and the base core is rotatable around a fixed axis in the plane perpendicular to the interlayer under the control of the switch.

17. The display bracket according to claim 14, wherein the display bracket further comprises:
a connector, one end of the connector being movably connected to the first arm rod, the other end of the connector being fixedly connected to the display, the display being allowed to make a lockable free movement with respect to the first arm rod via the connector.

18. The display bracket according to claim 17, wherein the connector comprises a first member and a second member connected to one another, the first member is connected to the first arm rod, and the second member is fixedly connected to the display.

19. The display bracket according to claim 18, wherein the first member and the first arm rod are connected by means of a hinged connection, the second member is rotatable around a fixed axis with respect to the first member.

20. The display bracket according to claim 18, wherein the first member and the second member are connected by means of a hinged connection, the first member is rotatable around a fixed axis with respect to the first arm rod.
